(19) United States
(12) Patent Application Publication
(10) Pub. No.: US 2001/0013513 A1
(43) Pub. Date: Aug. 16, 2001

(54) Hair curling iron with radiant heating elements

(76) Inventor: Wing-Kin Chan, Kowloon (HK)

Correspondence Address: JACOBSON HOLMAN PLLC, 400 SEVENTH STREET N.W., SUITE 600, WASHINGTON, DC, 20004, US

(21) Appl. No.: 09/496,182

(22) Filed: Feb. 2, 2000

(51) Int. Cl. H05B 3/02; A45D 1/02

(52) U.S. Cl. 219/225; 219/221; 219/227

(57) ABSTRACT

An improved hair curling iron 1 with a radiant heat source 21 which emits visible light during operation in which the instantaneous intensity of the emitted visible light is substantially commensurate with the instantaneous power across the said heating element. Advantage of this improved iron includes a fast response time because of the radiant nature of the heating source and an improved, and more convenient, visual indication of the instantaneous operation conditions of the iron resulting from the visible light emitted by heating element which is concurrently generated with the useful radiant heat.

### FIELD OF THE INVENTION

The present invention relates to a hair curling apparatus and, more particularly, to an electric hair curling iron utilising a radiant heat source which emits visible light during operation.

### BACKGROUND OF THE INVENTION AND PRIOR ART

Hair curling irons are used in many homes and provide a simple and effective way for speedy hair curling and styling. A typical conventional hair curling iron is substantially elongate, comprising an insulated handle, a heated barrel and, usually, a spring-biased hair clamping means to retain the hair to be curled on the heated barrel during application. The barrel is usually a metallic heat-conductive tube inside which there are encased electric heating elements, which are usually non-glowing resistive heating filaments, for generating the heat necessary for hair curling. The heating elements are usually spaced slightly away from the internal barrel surface to prevent extreme localised heat from appearing on the barrel surface which may cause localised burns to the hair in contact.

Transfer of heat from the heat source to the surface of the conductive barrel is usually by way of conduction or convection. Forced air circulation means are sometimes provided to improve air circulation inside the barrel to promote convection heat transfer. To better preserve the heat generated for hair heating, the longitudinal periphery of the heat-conductive barrel is usually fully enclosed so that the heat generated is bettery entrapped. With forced convection and a heating source which is not in direct contact with the inside of the barrel, a reasonably evenly distributed heat pattern will appear on the barrel surface.

A curling iron employing this kind of standard heating source usually has a rather slow response time in that it takes a considerable time to heat up and cool down. A further disadvantage of a this type of conventional hair curler is that because the heating elements are concealed within the barrel, a user could not assess from the appearance of the iron to determine whether it is on, off or whether it has reached its desired working temperature. While some conventional hair curlers do provide a indicating lamp on the handle portion to indicate their operating conditions, such an indicating lamp does not, however, directly represent the real operating status of the heating elements and, therefore, are only of limited use. Furthermore, such an indicating lamp is usually small and can only be seen from a certain defined range of angles. The lamp will be hidden from a user in a wide range of angles, resulting in an extensive range of blind spots.

### OBJECT OF THE INVENTION

Therefore, it is an object of the present invention to provide a hair curler with an improved heating element so that greatly shortened heat-up and -down times can be achieved. It is also an object of the present invention to provide a hair curling iron in which the operating conditions can be assessed from its external appearance, thereby alleviating the inconvenience connected with a localised indicator. At a minimum, it is an object of the present invention to provide the public with a useful choice.

### SUMMARY OF THE INVENTION

According to the present invention, there is provided an electric hair curling iron comprisng a substantially thermally insulated handle, a thermally conductive and substantially elongate barrel and a heating element, wherein said insulated handle is connected to said barrel and said heating element is inside said barrel, characterised in that said heating element is a distributed radiant heating element which extends along a substantial portion of the length of said barrel, generates radiant heat and emits visible light along its length during operation, and a substantial portion of said barrel is substantially transparent to both radiant heat and visible light.

Preferably, a substantial portion of the barrel of the iron is made of a material which is substantially transparent to both radiant heat and visible light.

Preferably, a plurality of slots or apertures are formed on said barrel to permit dissemination of radiant heat and visible light generated within said barrel beyond said barrel.

Preferably, an elongate quartz collar is inserted along a substantial length of said barrel between said heating element and said barrel and said quartz collar is coloured.

Preferably, the instantaneous intensity of the emitted visible light is substantially commensurate with the instantaneous power across the said heating element.

### BRIEF DESCRIPTION OF THE DRAWINGS

A preferred embodiment of the present invention will now be explained, by way of example and with reference to the accompanying drawings, in which:

FIG. 1 is the top plan view of the first and second embodiments of the present invention; and

FIG. 2 is the exploded side view of the first embodiment of the present invention.

### DETAILED DESCRIPTION OF THE PREFERRED EMBODIMENT

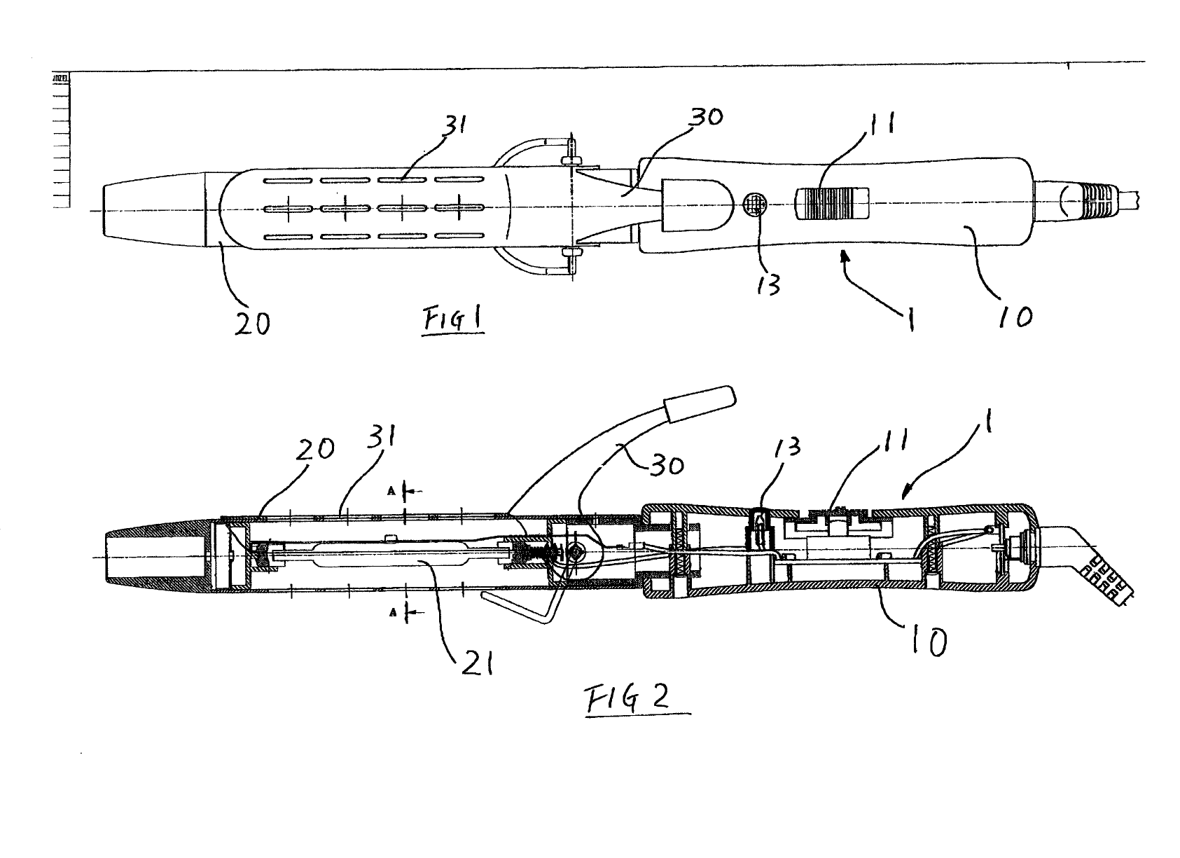

Referring to FIGS. 1 and 2, there is shown a preferred embodiment of a hair curling iron 1 of the present invention comprising a handle 10, a heat-conductive barrel 20 and a hair retention clip 30. The clip 30 is usually provided although not essential to the working of the present invention.

The handle 10 is made substnatially of a thermally insulated material, such as plastics, synthetic polymers or the like, for the convenience of an intened user. On the handle 10 there is provided a power switch 11 for turning the curling iron 1 on or off, a power level controller (not shown) which varies the power supply to the heating element 21 and an indicating device in the form of an indicating lamp 13 to indicate whether the device is being switched on or off.

The barrel 20 is elongate and substantially tubular, with one end connected to the insulated handle 10 and the other end extending axially away from the abutment between the handle 10 and the barrel 20. Inside the elongate barel 20 there is provided a distributed radiant heating source which runs along a substantial portion of the length of the barrel.

The radiant heating element 21 is a distributed heating source which simultaneously generates radiant heat and visible light radially along a substantial portion of its length. An example of a suitable heating element is a high power incandescent halogen lamp. With such a distributed heat source, a substantial portion of the inside of the barrel 20 is irradiated. To facilitate transmission of the radiant heat and visible light beyond the inside of the barrel 20 and to reach the hair to be styled, the barrel 20 is preferably made of a material which is transparent to both radiant heat and visible light.

Alternatively, where the barrel 20 itself is not made of such a transparent material, as is the iron of the present embodiment, substantial transparency to both radiant power and visible light can still be achieved by formation of slots or apertures 31 on the barrel, thereby creating a substantially transparent environment for the dissemination of the generated radiant heat and visible light beyond the barrel surface.

To prevent hair from penetrating through the slots or apertures 31 and from being caught and burned by the heating elements, there is provided an elongate quartz collar (not shown) which is inserted between the barrel 20 and the heating elements 21. As a quartz collar is transparent to both radiant heat and visible light, it physically separates hair from the heating elements but at the same time permits transmission of radiant heat and visible light beyond the barrel. Furthermore, such a collar acts as a heat buffer which would improve the distribution of heat on the barrel which is resulting from convection and conduction.

Since the heating source of the present invention is characterised by its simultaneous emission of radiant heat and visible light during operation and because of the necessary correlation which exists between intensity of the visible light and the almost instantaneous heating level of the heating element, this characteristic could be utilised as a visual indication of the instantaneous operating condition of the iron. A user would naturally treat an intensely lit barrel with more care and respect, thereby alleviating the risk of burns resulting from unintentional contacts with a heated barrel.

To convey a stronger visual impact on a user and keep the user aware of a hot barrel, the quartz collar is preferably coloured, for example, red, magenta or other ‘hot’ colour. Such a hot colour would send a stronger warning message to a user who would then treat the device with utmost respect. This colouring may be done by loading the quartz tube with a colouring agent absorbing blue or green light so that red, infrared, or other selected radiation is transmitted without significant attenuation.

Furthermore, as a distributed heating element generates visible light in all radial directions along its length and the barrel is designed to permit visible light dissemination in all radial directions along its length, the working condition of the iron could be observed from almost all orientations about the iron and at a distance. Unlike conventional irons with a localised operation indicating lamp which can be hidden from a user's sight, there is no obvious blind spot in the present invention which would hide the operating conditions of the iron from a user.

With the use of a distributed radiant heating element of the present description, there is now provided an improved hair curling iron having a very responsive heating source which simultaneously gives out both radiant heat and visible light. As the intensity of the visible light is commensurate with the instantneous power supplied to the heating source and the barrel is substantially transparent to visible light, this visible light serves as an direct operation indicator which are observable from almost all orientation and makes the iron safer to use.

Thus, the present invention provides a curling iron in which a substantially distributed heat-and-light radiant source is provided inside a barrel which is substantially transparent to radiant heat and visible light so that visible light generated by the heating element which is commensurate with the instantaneous radiant thermal power produced by the same element can be transmitted beyond the barreland observable from outside.

Although the invention has been described with reference to preferred embodiments, these are not to be considered limiting to the scope of the invention which is defined in the appended claims. Integers recited in the description are deemed to incorporate equivalents where appropriate to those skilled in the art to which the invention relates.

1. An electric hair curling iron comprising a substantially thermally insulated handle, a thermally conductive and substantially elongate barrel and a heating element, wherein said insulated handle is connected to said barrel and said heating element is inside said barrel, characterised in that said heating element is a distributed radiant heating element which extends along a substnatial portion of the length of said barrel, generates radiant heat and emits visible light along its length during operating, and a substantial portion of said barrel is substantially transparent to both radiant heat and visible light.

2. A curling iron as claimed in claim 1, wherein said barrel is made of a material which is substantially transparent to both radiant heat and visible light.

3. A curling iron as claimed in claim 1, wherein a plurality of slots or apertures are formed on said barrel to permit dissemination of radiant heat and visible light generated within said barrel beyond said barrel.

4. A curling iron as claimed in claim 3, wherein an elongate quartz collar is inserted along a substantial length of said barrel between said heating element and said barrel.

5. A curling iron as claimed in claim 4, wherein said quartz collar is coloured.

6. A curling iron as claimed in claim 1, further characterised in that the instantaneous intensity of the emitted visible light is substantially commensurate with the instantaneous power across the said heating element.
